(19) United States
(12) Patent Application Publication
(10) Pub. No.: US 2018/0069466 A1
(43) Pub. Date: Mar. 8, 2018

(54) A METHOD AND REGULATOR FOR REGULATING A POWER CONVERTER

(71) Applicant: GE Aviation Systems, LLC, Grand Rapids, MI (US)

(72) Inventor: Kenneth Howrds TRACY, Smithtown, NY (US)

(21) Appl. No.: 15/561,526

(22) PCT Filed: Apr. 16, 2015
(86) PCT No.: PCT/US2015/026183

§ 371 Date: Sep. 26, 2017

(51) Int. Cl. H02M 1/00; G05F 1/66

(52) U.S. Cl. CPC H02M 1/00; H02M 2001/0003; G05F 1/66

(57) ABSTRACT

A method and regulator for regulating a power converter includes an integrator circuit coupled with a voltage output from the power converter, a comparator circuit receiving a target voltage signal indicating a target voltage output of the power converter, and the integrated voltage signal as inputs, and a driving circuit receiving the comparator output signal and configured to drive the power converter, wherein the regulating system controls the power converter to generate a voltage output consistent with the target voltage output on a cycle per cycle basis.

### BACKGROUND OF THE INVENTION

Electrical power systems, such as those found in an aircraft power distribution system, employ power generating systems or power sources, such as generators, for generating electricity for powering the systems and subsystems of the aircraft. As the electricity traverses electrical bus bars to deliver power from power sources to electrical loads, power regulators dispersed throughout the power system ensure the power delivered to the electrical loads meets the designed power criteria for the loads. Power regulators can, for instance, provide step-up or step-down power conversion, and direct current (DC) to alternating current (AC) power conversion, or AC to DC power conversion.

### BRIEF DESCRIPTION OF THE INVENTION

In one aspect, a method of regulating a power converter includes receiving, by a power converter, an input power from a power source, converting, by the power converter, the input power to an output voltage waveform during a cycle period, integrating, by an integrator circuit, the output voltage waveform during the cycle period, comparing the integrated output voltage waveform and a reference value, determining that the integrated output voltage waveform satisfies the comparison, and in response to determining the integrated output voltage waveform satisfies the comparison, ceasing the converting until the end of the cycle period, and returning to the converting during a next cycle period.

In another aspect, a regulator for a power converter includes an integrator circuit configured to receive a voltage output from a power source, integrate the voltage output, and generate an integrated voltage output signal, wherein the integration circuit has an integration cycle period that is faster than a power converter cycle period of the power source, a comparator circuit configured to receive a target voltage signal from the power converter, and generate a comparator output signal based on a comparison of a target voltage signal and the integrated voltage signal, and a driving circuit configured to receive the comparator output signal and drive the power converter based at least in part on a determination by the comparator circuit that the integrated voltage output signal satisfies a comparison with the target voltage signal.

In yet another aspect, a power converter system includes a power converter coupled with an input power source and having a target voltage signal, a cycle period, and configured to convert the power source to a voltage output, and a regulating system having an integrator circuit configured to receive the voltage output from the power converter, integrate the voltage output, and generate an integrated voltage output signal, wherein the integration circuit has an integration cycle period that is faster than a power converter cycle period, a comparator circuit configured to receive a target voltage signal from the power converter, and generate a comparator output signal based on a comparison of a target voltage signal and the integrated voltage signal, and a driving circuit configured to receive the comparator output signal and drive the power converter based at least in part on a determination by the comparator circuit that the integrated voltage output signal satisfies a comparison with the target voltage signal.

### BRIEF DESCRIPTION OF THE DRAWINGS

In the drawings:

FIG. 1 is a top down schematic view of the aircraft and power distribution system.

FIG. 2 is a schematic view of a power converter system of the power distribution system.

FIG. 3 is a flowchart of the method of regulating the power converter.

FIG. 4 is a set of graphs illustrating application of the method of FIG. 3.

FIG. 5 is a set of graphs illustrating an alternative application of the method of FIG. 3.

### DESCRIPTION OF EMBODIMENTS OF THE INVENTION

The described embodiments of the present invention are directed to a method and apparatus for regulating a power converter connected to a power source and having a converter input and a converter output. One example environment where such a method and apparatus can be used includes, but is not limited to, a power distribution system for an aircraft. While this description is primarily directed toward a power distribution system for an aircraft, it is also applicable to any environment using a regulator for regulating a power converter.

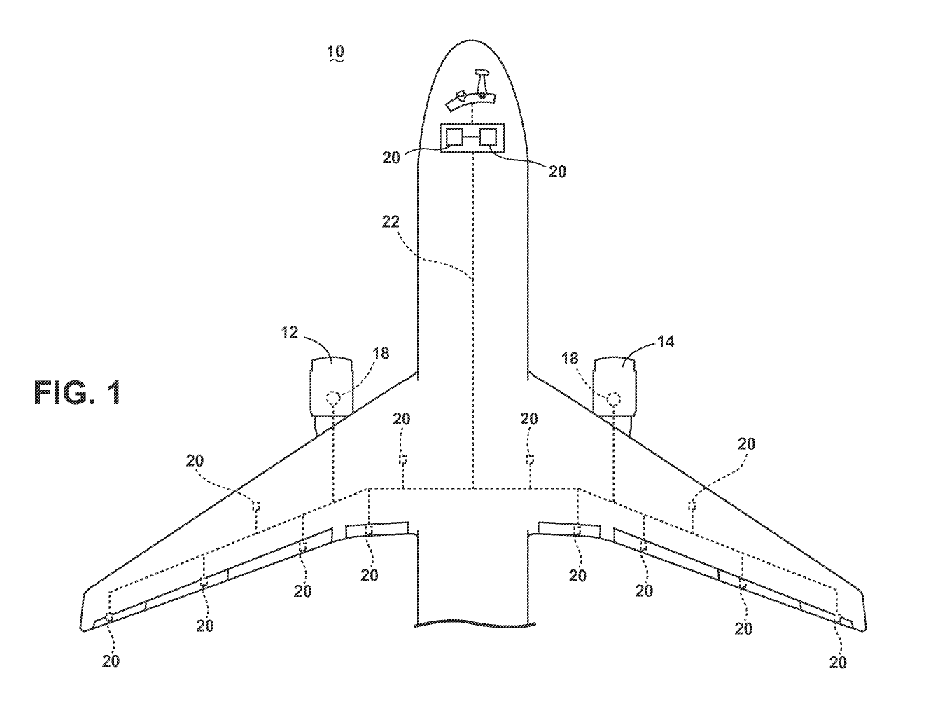

As illustrated in FIG. 1, an aircraft 10 is shown having at least one gas turbine engine, shown as a left engine system 12 and a right engine system 14. Alternatively, the power system can have fewer or additional engine systems. The left and right engine systems 12, 14 can be substantially identical, and can further include at least one power source, such as an electric machine or a generator 18. The aircraft is shown further having a set of power-consuming components, or electrical loads 20, such as for instance, an actuator load, flight critical loads, and non-flight critical loads. Each of the electrical loads 20 is electrically coupled with at least one of the generators 18 via a power distribution system, for instance, power transmission lines or bus bars 22.

In the aircraft 10, the operating left and right engine systems 12, 14 provide mechanical energy which can be extracted via a spool, to provide a driving force for the generator 18. The generator 18, in turn, generates power, such as AC or DC power, and provides the generated power to the bus bars 22, which delivers the power to the electrical loads 20 for load operations. Additional power sources for providing power to the electrical loads 20, such as emergency power sources, ram air turbine systems, starter/generators, or batteries, can be included, and can substitute for the power source. It will be understood that while one embodiment of the invention is shown in an aircraft environment, the invention is not so limited and has general application to electrical power systems in non-aircraft applications, such as other mobile applications and non-mobile industrial, commercial, and residential applications.

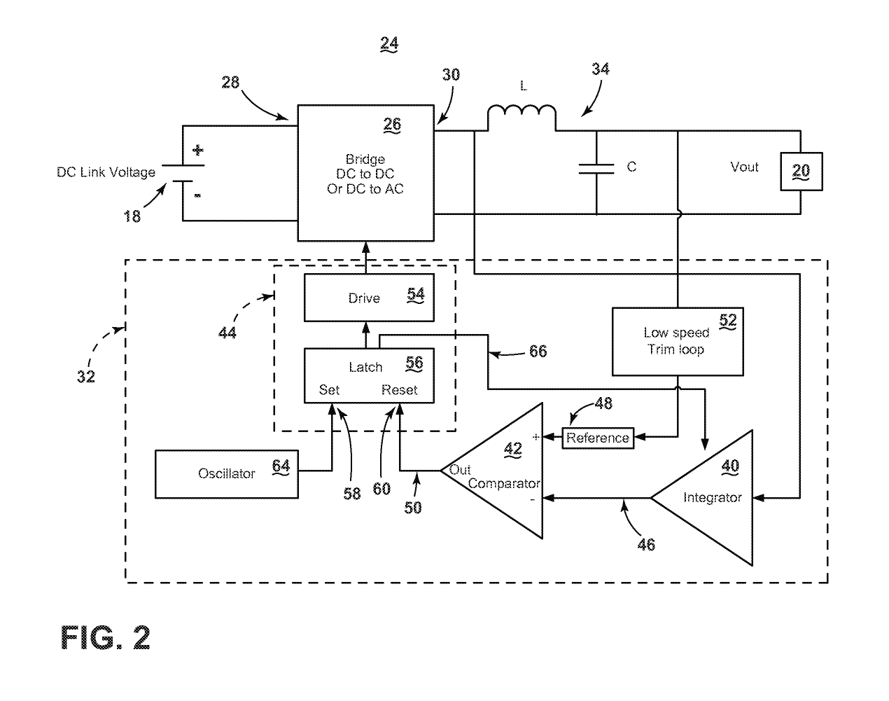

FIG. 2 illustrates an embodiment of a power converter system 24 for regulating power provided from the generator 18 to the electrical loads 20. As shown, the power converter system 24 includes a power converter 26. The power converter 26 has an input 28 electrically coupled with the generator 18, and a voltage output 30 electrically coupled with the electrical load 20. The power converter 26 changes, adapts, or otherwise converts power generated by the generator 18, illustrated as a DC generator 18, to a target power output for the electrical load 20. The power converter 26 is coupled with a regulator system 32 for controlling operation of the power converter 26. The power converter system 24 is configured to perform one or more cycles of operation. A cycle of operation can be a period of time for the power converter 26 to operate, also called a power converter duty cycle. The power converter 26 is expected to convert power generated by the generator 18, and deliver the target power output to the load 20 during each power converter duty cycle. One example of a power converter 26 may include, but is not limited to, a switching conversion embodiment, wherein a full bridge (e.g. four switches), or half bridge (e.g. two switches in addition to a buck switch) can provide for a modulated power conversion without voltage or phase conversion.

The power converter system 24 is further shown having an optional power converter output filter, such as an inductor-capacitor (LC) filter 34, which can operate to filter transient variations in the power converter output 30, and provide a uniform power output to the electrical load 20. For example, the power converter 26 can be configured to convert the power converter input 28 to a voltage waveform having a variable voltage output 30 (e.g., via pulse width modulation). The LC filter 34 can operate to filter the variable voltage output 30 to provide a more consistent power output for the electrical load 20.

The regulator system 32 includes an integrator circuit 40, a comparator circuit 42, and a driving circuit 44. The integrator circuit 40 is coupled with the voltage output 30 of the power converter 26, and is configured to integrate, summate, or accumulate the voltage output 30 over a period of time. The integrator circuit 40 provides an integrator output signal 46, indicating the integration of the voltage output 30 as a function of time, to the comparator circuit 42. As used herein, “integrate” or “integration” can include summating or accumulating the magnitude of the voltage output 30 over the period of time such that the integrator output signal 46 indicates or is representative of the total amount of voltage received at the voltage output 30 in, or approaching, real time.

For example, the integrator circuit 40 can include or define an integration sample or sampling period that is significantly less than, or has a significantly higher resolution than, the power converter duty cycle. In this sense, the integrator circuit 40 is configured to or is capable of integrating the voltage output 30 during the power converter 26 period of time. In one non-limiting example, contrasting the power converter duty cycle to the integration sample period, the integration sample period of time can be one tenth as long as (i.e. at least ten times as fast as, or ten times higher resolution than) the power converter duty cycle. While the integration sample period is described as one tenth as long as the power converter duty cycle, any integration sample period can be included, so long as the integration sample period is at least ten times as fast as the power converter duty cycle. It is understood that a faster integration sample period ratio, with respect to the power converter duty cycle will improve the resolution or accuracy of the integration functions by performing the integration functions faster, or with a higher number of incremental integration steps, compared with a slower integration sample period ratio. Additionally, the integrator circuit 40 can be configured such that the integration of the voltage output 30 can be reset or the integrator output signal 46 can be zeroed out, in response to an external command, such as a reset signal from another component or module.

While the integrator circuit 40 is described as coupled with the voltage output 30, the integrator circuit 40 can include any electrical coupling that is configured to deliver the magnitude of the voltage output 30 to the integrator circuit 40. For example, the integrator circuit 40 can be configured to receive, sense, or measure a voltage value directly from the voltage output 30. Additionally or alternatively, the integrator circuit 40 can, or can be coupled with another component to, receive, sense, or measure the voltage. For instance, the integrator circuit 40 can be coupled to a voltage sensor, and the voltage sensor can provide a signal indicating the respective voltage output 30. In the previous example, the additional component can operate, sense, or measure the voltage output 30 over or during a period of time less than or equal to the integration sample period.

Sensing or measuring the voltage output 30 can include determining a value indicative of or related to the magnitude of the voltage output 30, rather than directly sensing or measuring the voltage output 30 itself. Furthermore, while one non-limiting example of a voltage sensor has been described, embodiments of the invention can include sensing or measuring of electrical characteristics that can be utilized to determine a magnitude of voltage output 30 by the power converter 26. Sensed or measured values can be provided to additional components. For instance, the value can be provided to a controller, and the controller can perform processing on the value to determine a magnitude of the output voltage 30 or an electrical characteristic representative of said magnitude. In the embodiments described above, the sensing or measuring, or the determination by a controller, can be assimilated with the integrator circuit 40. Moreover, additional circuitry or functional components can be included to, for example, condition the voltage output 30 for use or integration by the integrator circuit 40.

Furthermore, while the integrator circuit 40 is illustrated as an integrated circuit or operational amplifier, embodiments of the invention can include, but are not limited to, an integrator circuit 40 including a controller and a computer program having an executable instruction set for determining the integration of the voltage output 30, as described above. The computer program can include a computer program product that can include machine-readable media for carrying or having machine-executable instructions or data structures stored thereon. Such machine-readable media can be any available media, which can be accessed by a general purpose or special purpose computer or other machine with a controller. Generally, such a computer program can include routines, programs, objects, components, data structures, algorithms, etc., that have the technical effect of performing particular tasks or implement particular abstract data types. Machine-executable instructions, associated data structures, and programs represent examples of program code for executing the exchange of information as disclosed herein. Machine-executable instructions can include, for example, instructions and data, which cause a general purpose computer, special purpose computer, or special purpose processing machine to perform a certain function or group of functions.

The comparator circuit 42 is configured to receive the integrator output signal 46, and a reference signal 48 indicating the target power output desired during each power converter duty cycle. The comparator circuit 42 can be configured to generate a comparator output signal 50 based at least in part on a comparison of the integrator output signal 46 and the reference signal 48. In one non-limiting example, the reference signal 48 can include a reference threshold value such that the comparator circuit 42 can compare the integrator output signal 46 with the reference threshold value, and determine if the integrator output signal 46 satisfies the reference threshold value. As used herein, the term “satisfies” can mean, for example, equal to or less than the respective value or reference signal 48. It will be understood that such a determination can easily be altered to be satisfied by a positive/negative comparison or a true/false comparison. In response to a determination that the comparison satisfies the reference signal 48, the comparator circuit 42 can, for example, generate a comparator output signal 50 indicating satisfaction of the comparison. It will be understood that the comparator output signal 50 can include a high or low signal, or virtually any other signal waveform designated to indicate the satisfaction of the comparison.

Embodiments of the invention can further include a predetermined reference signal 48. For example, the predetermined reference signal 48 can be set, determined, or otherwise selected based in part on the electrical characteristics of the power converter 26, LC filter 34, or electrical load 20, and to set the target power or voltage output for a power converter duty cycle to a non-variable value (e.g., such as 28 VDC). Additionally or alternatively, embodiments of the invention can further include a reference signal 48 that varies due to the electrical characteristics of the power converter system 24. In this embodiment, the reference signal 48 variations can be at least partially due to the electrical characteristics of the power converter 26, LC filter 34, or electrical load 20. In addition, reference signal 48 variations can be at least partially due to electrical characteristic variations due to, for example, instantaneous power draw by the electrical load 20 (e.g. during transient electrical characteristics caused by the load 20 powering on or powering off), a variable generator 18 power supply at the power converter input 28, or power conversion variations generated at the power converter output 30. In the previous examples, the reference signal 48 can alter the desired target power output to account for such transient electrical characteristics. For instance, the reference signal 48 can increase the target power output during periods of high power draw by the electrical load 20, or by additional target power output shaping techniques.

For example, as illustrated, the reference signal 48 can receive an input from a low-speed trim loop 52 that further receives the actual power output delivered to the electrical load 20, downstream of the LC filter 34. The low-speed trim loop 52 can alter the desired target power output, and thus, the reference signal 48 for example, based at least in part on instantaneous electrical transient characteristics, estimated transient characteristics, a moving average of number of immediately-preceding power converter duty cycles, inaccuracies of the output sensing or measuring, or a weighted average of any of the previously-mentioned electrical characteristic considerations. Furthermore, while a low-speed trim loop 52 is illustrated, the reference signal 48 or target power output value can be alternatively determined using a controller and a computer program having an executable instruction set, as explained above. Additional electrical considerations affecting the reference signal 48 or target power output value can be included.

The comparator output signal 50 is delivered to the driving circuit 44, which as shown, includes a power converter driving controller 54 and a latch circuit 56. The power converter driving controller 54 is configured to drive the power converter 26, that is, control the operation of the converting, by the power converter 26, from the converter input 28 to the converter output 30. As explained in the controller example above, the driving controller 54 can be configured to execute a computer program having an executable instruction set to perform the control the converting operations.

The latch circuit 56 is shown having a “set” input 58 and a “reset” input 60, and a latch output signal 62. The latch circuit 56 is configured to continuously set the latch output signal 62, for example, to a high signal value, such as SVDC, in response to a triggering input received at the set input 58. The latch output signal 62 continues to output this high output signal 62 until the latch circuit 56 is reset, that is, until the latch circuit 56 receives a triggering input from the reset input 60. Once reset, the latch circuit 56 is configured to continuously set the latch output signal 62 to a different value, for example, to a low signal value, such as zero or 1 VDC, until the latch circuit 56 again receives a triggering set input 58. While high/low values are described as signals in response to triggering events, it will be understood that any designated values capable of distinguishing between a first latch output signal and a second latch output signal can be used, and such signals can be easily altered to indicate high/low, low/high, true/false, positive/negative, or otherwise binary indicators.

As illustrated, the set input 58 of the latch circuit 56 is electrically coupled with an oscillator 64 configured to deliver a pulse output to the latch circuit 56 at a cycle period T, which can equal, but is not required to equal, the power controller duty cycle. The reset input 60 of the latch circuit 56 can be electrically coupled with the comparator 42 such that the reset input 60 receives the comparator output signal 50. In this sense, the pulse output of the oscillator 64 and a comparator output signal 50 indicating the satisfaction of the comparison can be configured to be, respectively, the triggering inputs for the set and reset inputs 58, 60. When the latch circuit 56 receives the pulse output of the oscillator 64, without receiving a triggering reset input 60, it delivers a latch output signal 62 to activate the driving controller 54, which in turn, activates the power converter 26 to convert the converter input 28 to the converter output 30. When the latch circuit 56 receives the triggering reset input 60, that is, an indication from the comparator circuit 50 that the comparison of the integrated output voltage satisfies the reference value 48, without receiving a triggering set input 58, it delivers a latch output signal 62 to deactivate the driving controller 54, which in turn, deactivates the power converter 26, stopping the power conversion and ending the power converter duty cycle. The latch circuit 56 can further include a reset output signal 66, triggered by the same configuration as the latch output signal 62, that is provided to the integrator circuit 40, and configured to reset or zero out the integration of the voltage output 30 or integrator output signal 46, in response to the reset output signal 66, such that the integrator circuit 40 can restart the integrating again.

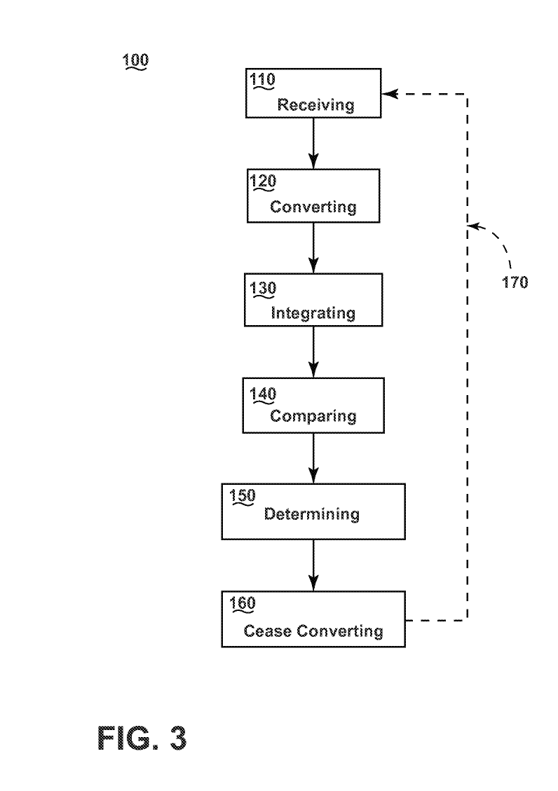

Turning now to FIG. 3, a method 100 of regulating the power converter 26 is described. The method begins with a receiving step 110, wherein the power converter 26 receives the converting input power 28 from the generator 18. Following the receiving step 100 is a converting step 120, wherein the power converter 26 converts power received from the generator 18 at the converting input 28 to an output power waveform at the power converter output 30. In this step, converting, by the power converter 26, can be controlled when the latch circuit 56 receives a pulse signal from the oscillator 64, indicating the beginning of a first cycle period T. In response, the latch circuit 56 delivers a latch output signal 62 to the driving controller 54 indicating the beginning of a power converter duty cycle, and delivers a reset output signal 66 to the integrator circuit 40 to reset or zero the integrator circuit 40, as explained above.

Next, the integrator circuit 40 performs an integrating step 130, wherein the circuit 40 integrates the output voltage waveform over one or more sample periods during the cycle period, and delivers an integrated or summated output value as an integrator output signal 46 to the comparator circuit 42. The comparator circuit 42 performs a comparing step 140 such that the integrated output voltage waveform indicating the amount of power converted by the power converter 26 is compared with a reference value 48 indicating the desired amount of power to be converted by the power converter 26 during the first cycle period T. Following the comparing step 140 is a determining step 150, wherein the comparator circuit 42 determines, based on the comparison of the comparing step 140, if the integrated output voltage waveform satisfies the comparison, as explained above.

In response to a determination that the comparison is satisfied, that is, when the integrated output voltage waveform is equal to or greater than the desired amount of converted power (e.g. the reference value 48), the method 100 operates a ceasing converting step 160, wherein the comparator circuit 42 delivers a comparator output signal indicating the satisfaction of the comparison, which is received at the reset input 60 of the latch circuit 56, and consequently operates the driving controller 54 to cease the conversion of power by the power converter 26, thus ending the power converter duty cycle which can occur before the end of the cycle period T. The cessation continues until the next cycle period T as determined by the oscillator 64, when the oscillator delivers another pulse signal to the set input 58 of the latch circuit 56. In this sense, the beginning of the second cycle period is at least partially based on receiving a timing or pulse signal from the oscillator 64 and the satisfaction of the comparison in the comparing step 140.

The method 100 can further include a repeating step (indicated by dotted line 170) such that the method 100 is repeated for each cycle period T, for example, a second cycle period, a set of cycle periods, or for each successive cycle period, wherein the method steps 100 operate to self-regulate the output of the power converter on a cycle-by-cycle basis. The sequence depicted is for illustrative purposes only and is not meant to limit the method 100 in any way as it is understood that the portions of the method can proceed in a different logical order, additional or intervening portions can be included, or described portions of the method can be divided into multiple portions, or described portions of the method can be omitted without detracting from the described method.

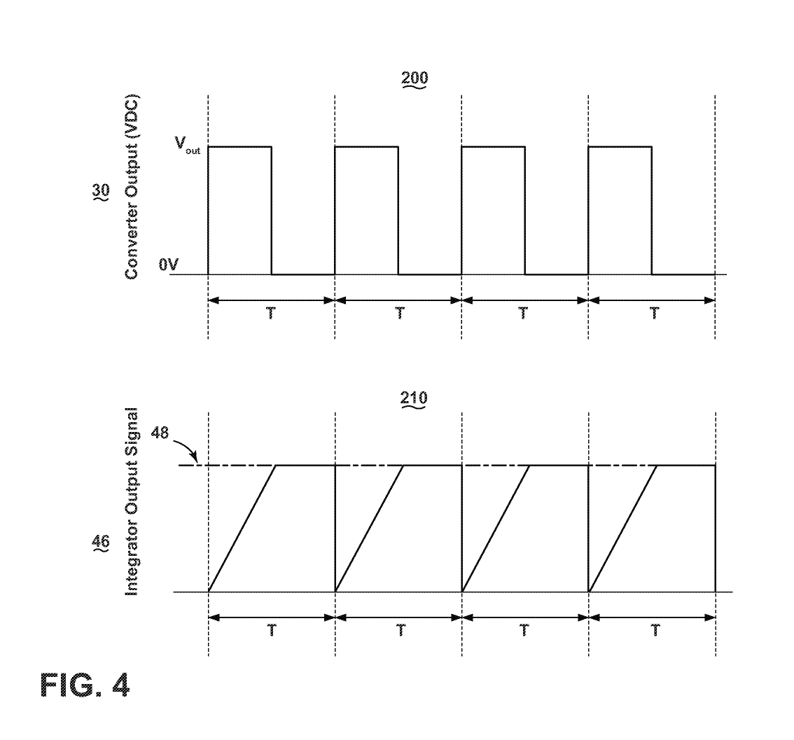

FIG. 4 illustrates an example application of the method 100 of FIG. 3. As shown, for each cycle period of time (denoted “T” along the x-axis), the power converter 26 converts power received at the converter input 28 to the voltage output 30, shown in the first graph 200. Also shown in a time-aligned second graph 210, is the integrator output signal 46 over the same cycle periods of time (T). As illustrated, the power converter 26 delivers the voltage 30, for example, at output voltage “Vout”, to the electrical load 20 over the cycle period of time T, which is simultaneously being integrated by the integrator circuit 40, as represented by the integrator output signal 46, which further indicates the accumulation of power converted in the cycle period T. When the integrator output signal 46 of the second graph 210 reaches the desired amount of power converted, as indicated by the reference signal 48, the method 100 ceases the power converting, as indicated by the drop of converter output 30 in the first graph 200 to zero. Correspondingly, the integrator output signal 46 of the second graph 210 remains constant, as no more output power is accumulated, and is finally reset to zero at the start of the following period T. Alternative embodiments of the invention can include configurations wherein the integrator output signal 46 can be immediately reset upon satisfaction of the comparison of the output signal 46 with the reference signal 48, as opposed to at the beginning of each successive cycle period T.

Moreover, while the power conversion shown in FIG. 4 can include a power conversion from, for example, a DC input 28 to a DC output 30 (i.e. DC to DC power conversion), embodiments of the invention can include a power conversion from a DC input 28 to an AC output (i.e. DC to AC power conversions). In such an embodiment, the integrator circuit 40 can integrate, for example, the magnitude or absolute amount of power converted.

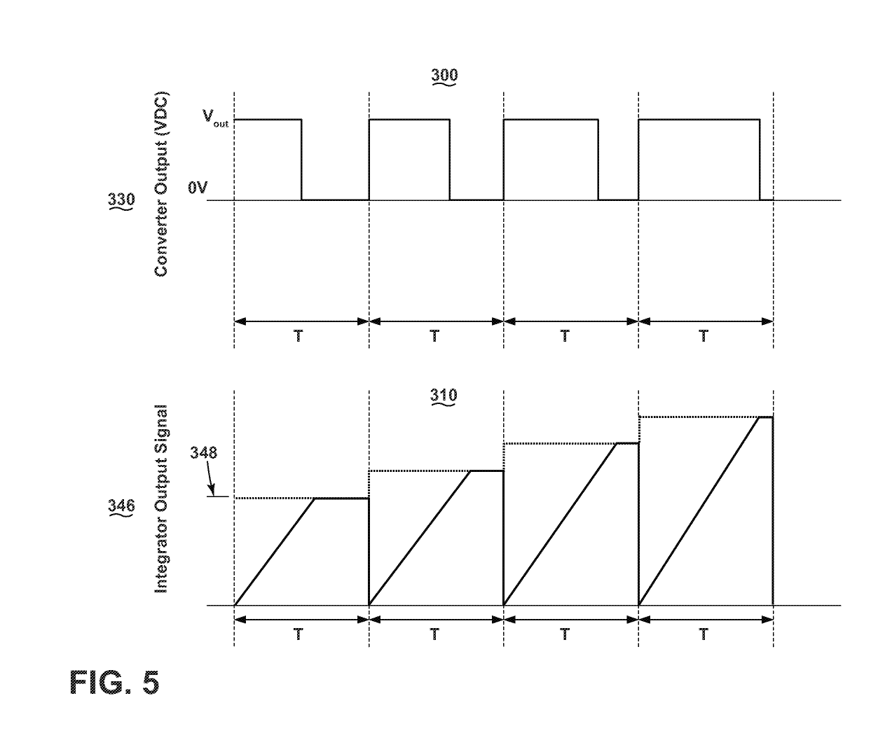

FIG. 5 illustrates yet another embodiment of the invention, wherein, for example, the desired amount of converter power can vary per cycle period, such as where the power converter 26 can be delivering an increasing amount of converter power according to pulse width modulation. As seen in the first graph 300 of FIG. 5, for each cycle period of time (denoted “T” along the x-axis), the power converter 26 converts power received at the converter input 28 to a converter output power 330, wherein each successive cycle period of time has a higher duty cycle. Also shown in a time-aligned second graph 310, is the integrator output signal 346 over the same cycle periods of time (T). As illustrated, the power converter 26 delivers output power 330, for example, at output voltage “Vout”, to the electrical load 20 over the cycle period of time T, which is simultaneously being integrated by the integrator circuit 40, as represented by the integrator output signal 346, which further indicates the accumulation of power converted in the cycle period T. Also shown in the second graph 310 is the reference signal 348, which increases from period to period, to correspond with a desired increase in the amount of power converted, due to expected increase in duty cycle. In this sense, the reference signal 348 can vary in order to drive the duty cycle for each power converter 26 cycle period according to a desired output voltage waveform, such as pulse width modulation. While an increasing duty cycle is illustrated, embodiment of the invention can include increasing, decreasing, or alternatingly increasing and decreasing duty cycles, as controllable by the method 100 described.

Many other possible embodiments and configurations in addition to that shown in the above figures are contemplated by the present disclosure. For example, one embodiment of the invention contemplates the oscillator 64 configured as a sub component of the driving circuit 44. Another embodiment of the invention contemplates the oscillator 64 removed from the regulator system 32 altogether, for example, where a common oscillator 64 is utilized to synchronize the power conversion over a set of power converters 26. Yet another embodiment of the invention contemplates incorporating the low-speed trim loop 52 to adjust the reference signal 48 only when the loop 52 determines that a variance of the converter output 30 exceeds a variance range or variance threshold. Additionally, the design and placement of the various components can be rearranged such that a number of different in-line configurations could be realized.

The embodiments disclosed herein provide a method and apparatus for regulating a power converter. The technical effect is that the above described embodiments enable the regulation of the power conversion from an input power to an output power according to the method described herein. One advantage that can be realized in the above embodiments is that the above described embodiments are configured to operate the power converter or regulate the output of the power converter on a cycle-by-cycle basis. Furthermore, the method and apparatus of regulation is entirely self-contained in the system, and does not require external inputs to provide accurate power regulation. By ensuring the system is self-contained and capable of regulating the power conversion on a cycle-by-cycle basis, existing components, such as stabilized error amplifiers and additional feedback controls can be removed while provide more accurate results.

Moreover, the above-described embodiments would be capable of converting power and driving electrical loads, wherein the loads subject the power converter system to abrupt changes, while providing less distortion. In certain embodiments of the invention wherein the electrical load subjects the power converter system to highly leading or lagging power factor loads, the regulating system would be able to adjust the power conversion, such as the duty cycle of the converter output, to the changing current, as needed, during the same cycle or successive cycles.

Another advantage that can be realized in the above embodiments is that the regulating system can improve the transient response of a switching power converter and improve the stability of a power converter where a conventional control loop is otherwise nearing its limits of phase margin in order to meet an imposed transient requirement. This is especially true in the case of a low frequency output DC to AC converters where the feedback loop requires a low pass filter sufficient to average out the rectified output waveform for comparison in the error amplifier.

To the extent not already described, the different features and structures of the various embodiments can be used in combination with each other as desired. That one feature cannot be illustrated in all of the embodiments is not meant to be construed that it cannot be, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of regulating a power converter, comprising:
receiving, by a power converter, an input power from a power source;
converting, by the power converter, the input power to an output voltage waveform during a cycle period;
integrating, by an integrator circuit, the output voltage waveform during the cycle period;
comparing the integrated output voltage waveform and a reference value;
determining that the integrated output voltage waveform satisfies the comparison; and
in response to determining the integrated output voltage waveform satisfies the comparison, ceasing the converting until the end of the cycle period, and returning to the converting during a next cycle period.

2. The method of claim 1, further comprising repeating the converting, the integrating, the comparing, the determining, and the ceasing the converting for successive cycle periods, wherein the repeating regulates the output of the power converter on a cycle-by-cycle basis.

3. The method of claim 1 further comprising sensing the output voltage waveform at the output of the power converter prior to the integrating.

4. The method of claim 1 wherein the integrating is performed in a period of time less than the first cycle period.

5. The method of claim 4 wherein the integrating is at least ten times as fast as the cycle period.

6. The method of claim 1 wherein the reference value is a predetermined reference value.

7. The method of claim 1 wherein the reference value is further determined based at least in part on a low-speed trim loop variation of the output voltage.

8. The method of claim 1 wherein the reference value varies according to a desired output voltage waveform.

9. The method of claim 1 further comprising determining the beginning of the second cycle period based on a timing signal and the satisfaction of the comparison.

10. The method of claim 9 wherein the determining further comprises driving the power converter with a latch circuit having the timing signal as a set input and the satisfaction of the comparison as a reset input.

11. The method of claim 9 wherein the determining further comprises resetting the integrator circuit.

12. A regulator for a power converter, comprising:
an integrator circuit configured to receive a voltage output from a power source, integrate the voltage output, and generate an integrated voltage output signal, wherein the integration circuit has an integration cycle period that is faster than a power converter cycle period of the power source;
a comparator circuit configured to receive a target voltage signal from the power converter, and generate a comparator output signal based on a comparison of a target voltage signal and the integrated voltage signal; and
a driving circuit configured to receive the comparator output signal and drive the power converter based at least in part on a determination by the comparator circuit that the integrated voltage output signal satisfies a comparison with the target voltage signal.

13. The regulator of claim 12 further comprising a low-speed trim loop configured to receive the voltage output from the power converter, and generate the target voltage signal based on a low-speed trim loop output.

14. The regulator of claim 12 wherein the driving circuit further comprises a latch circuit configured to receive the comparator output signal as a reset input signal and a cycle period signal as a set input signal.

15. The regulator of claim 14 wherein the latch circuit is further configured to define the cycle period of the power converter.

16. The regulator of claim 12 wherein the driving circuit is further configured to generate an integrator reset signal, wherein the integrator circuit is further configured to reset the integration based on the integrator reset signal.

17. A power converter system comprising:
a power converter coupled with an input power source and having a target voltage signal, a cycle period, and configured to convert the power source to a voltage output; and
a regulating system having:
an integrator circuit configured to receive the voltage output from the power converter, integrate the voltage output, and generate an integrated voltage output signal, wherein the integration circuit has an integration cycle period that is faster than a power converter cycle period;
a comparator circuit configured to receive a target voltage signal from the power converter, and generate a comparator output signal based on a comparison of a target voltage signal and the integrated voltage signal; and
a driving circuit configured to receive the comparator output signal and drive the power converter based at least in part on a determination by the comparator circuit that the integrated voltage output signal satisfies a comparison with the target voltage signal.

18. The system of claim 17 wherein the input power source is direct current and the voltage output is alternating current.

19. The system of claim 17 wherein the input power source is direct current and the voltage output is direct current.

20. The system of claim 17 wherein the power converter is coupled with a variable input power source.
